(19) United States
(12) Patent Application Publication
(10) Pub. No.: US 2007/0289848 A1
(43) Pub. Date: Dec. 20, 2007

(54) Web Covers for Conveyor Screens

(76) Inventors: David Rankin, Northern Ireland (GB); Anne Shanks, Northern Ireland (GB)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/570,387

(22) PCT Filed: Sep. 2, 2004
(86) PCT No.: PCT/GB04/03782

§ 371 Date: Oct. 30, 2006

(30) Foreign Application Priority Data
Sep. 3, 2003 (GB) 0320567.1

(51) Int. Cl. B65G 15/32

(52) U.S. Cl. 198/844.2

(57) ABSTRACT

A web cover for an endless conveyor is formed from one continuous belt of wear-resistant, non-metallic sheet material in which a plurality of closely spaced holes are provided. The web cover is endless and intended to overlie the screen of said conveyor wherein the web cover is formed with the ends of the belt being joined together by fastening means. The fastening means comprises two parts. Both parts have reflexive sections and have two limbs with one part being secured to each end of the belt with a limb above and below the said end of the belt. One part is provided with a lengthwise series of spaced hook elements and the other part is provided with a correspondingly spaced lengthwise series of apertures through which extends and is secured a rod around which each hook element is engagable and is held.

This invention relates to a web cover for an endless conveyor used primarily, but not necessarily for harvesting potatoes or other root vegetables (hereinafter referred to as “root crops”), whose screen is formed by a parallel rod conveyor, or series of conveyors and generally called a “web”.

A parallel rod conveyor or web consists of a plurality of rods attached to side belts. The web carries the root crop through a machine to a collection point while soil and other debris falls through the spacings between the rods. To aid separation of soil and debris from the root crop, the web is oscillated by the use of asymmetric rollers which act on the side belting causing it to vibrate. The root crop is carried over a series of webs and other types of soil separation mechanisms until it reaches the collection point. One of the problems with this method of soil separation is that is damage to the root crop occurs by repeated contact with the web as it is conveyed through the machine. As the root crop is carried along through the machine more soil is removed and the risk of damaging the root crop increases.

There is another problem with conventional webs in that they are not ideally suited for carrying some types of root crops, such as carrots and parsnips. Because the rods are secured at right angles to the direction of travel of the web, the spacing between the rods allows carrots and similarly shaped root crops to fall partly though the rods as there is inadequate support. The carrots or parsnips are then often damaged or broken in half on contact with the rollers on the machine because they are not supported sufficiently by the web. This damage is unacceptable and the existing conveyor screen disadvantageous.

An object of the present invention is to obviate or mitigate this disadvantage.

Accordingly, the present invention is a web cover for an endless conveyor, the cover being formed from a continuous belt of wear-resistant, non-metallic sheet material in which a plurality of closely spaced holes are provided, the web cover being endless and intended to overlie the screen of said conveyor.

Preferably, the web cover is formed with the ends of the belt being joined together by fastening means. The fastening means beneficially comprises two parts, both parts having reflexive sections and having two limbs with one part being secured to each end of the belt with a limb above and below the said end of the belt. One part is desirably provided with a lengthwise series of spaced hook elements and the other part being provided with a correspondingly spaced lengthwise series of apertures through which extends and is secured a rod around which each hook element is engagable and is held. The elongate belt is preferably loosely arranged around the screen which itself is arranged around a set of three or more parallel rollers, at least one of which is adapted to be driven, the root crop to be screened being fed onto the upper flight of the cover. Movement means may be provided to vibrate at least the upper flight of the screen.

Preferably also, the holes in the or each belt are similar and are provided in a regular pattern across and In particular to providing bridges of material between and at substantially right angles to adjacent parallel rods.

An embodiment of the present invention will now be described, by way of example, with reference to the accompanying drawings, in which:

FIG. 1 is a side view of a screen according to the present invention, showing two conveyors with a web cover over a second conveyor;

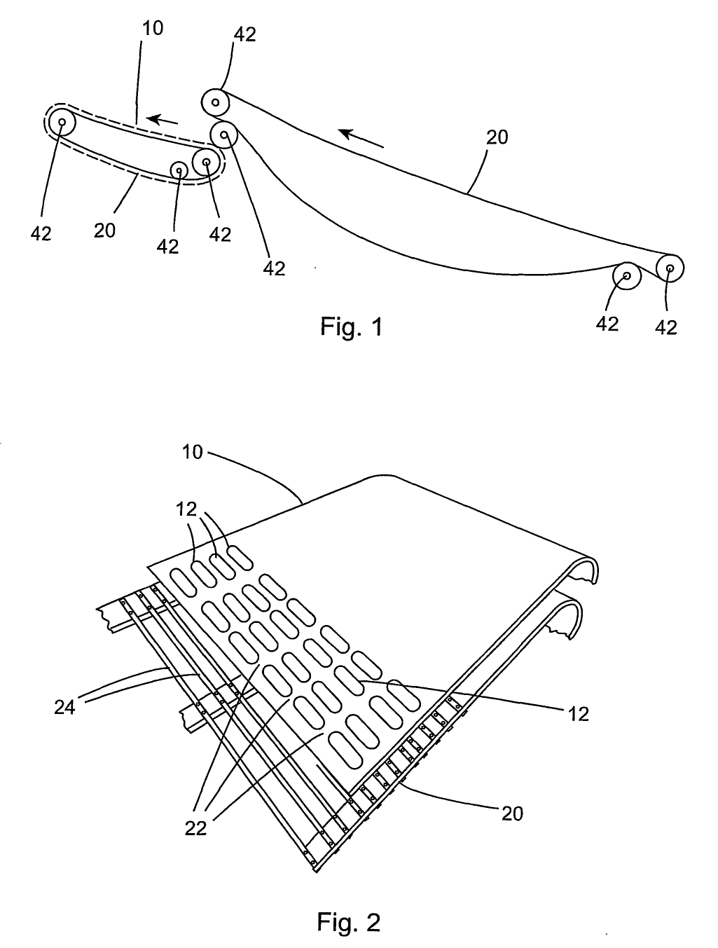

FIG. 2 is a perspective view of the web cover over the conveyor with some holes being shown; and

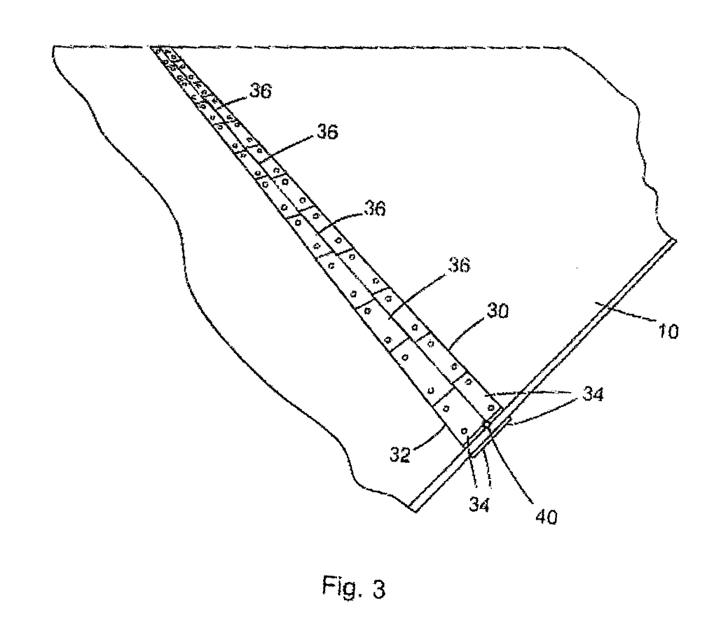

FIG. 3 is a perspective view of a part of the web cover showing fastening means, apertures in the cover not being shown.

Referring to the drawings, a web cover for a conveyor is formed from one continuous belt 10 of wear-resistant non-metallic sheet material. The belt 10 has a plurality of similar holes 12 spaced in a regular pattern thereacross. The holes 12 are substantially square, hexagonal or round. Square holes have typically a 10 mm radius on each corner. The belt 10 is formed of a multi-layered material, the topmost layer being a soft rubber or synthetic compound. The top covering is made of a high quality super-soft rubber compound which has the advantage of reducing damage and bruising on the root crop being harvested to a minimum. As an item of the root crop falls onto the belt 10 it will be cushioned by the top covering and so will incur little or no damage as it hits or moves across the belt. The top layer is made of a high-grade natural rubber compound which is cured to give a soft texture but which still has excellent resistance to abrasion. The softness of the rubber is dependent upon variations in temperature pressure and time taken during the curing process. This top covering is bonded to the other layers of the belt producing a very soft surface. This material combines the strength and wear resistance of a heavy duty rubber conveyor with the disadvantages of a hard wearing but highly shock absorbent, cushioned surface.

One elongate belt 10 is formed into a continuous belt with its ends joined together by fastening means. The fastening means (FIG. 3) comprises two parts 30, 32. Both parts 30, 32 have reflexive sections, each having two limbs 34 with one part 30 being secured to each end of the belt 10 with a limb 34 above and one below the said end of the belt 10. The parts are of metal or hard-wearing plastics material. The two limbs 34 of each part 30, 32 are secured together trapping the respective end of the belt 10. One part 30 is provided with a lengthwise series of spaced hook elements 36 and the other part 32 is provided with a correspondingly spaced lengthwise series of apertures 38 through which extends and is secured a hinge rod 40 around which each hook element 36 is engagable and is held. The elongate belt 10 overlies a conveyor screen 20 arranged around a set of three or more rollers 42 as shown, at least one of which is adapted to be driven. The items to be screened are fed onto the upper flight of the belt 10. Movement means in the form of power driven agitators are provided on the conveyor to vibrate at least the upper flight of the screen 20 and therefore the belt 10. The belt 10 is loosely arranged around the conveyor 20 or can be taut and movable with the conveyor screen 20. In either case, the web cover travels around and in the same direction as the conveyor screen. The lands 22 between the holes 12 in each row of the web cover provides bridging at right angles to the rods 24 and prevents passage of root crops through the holes. The two-part fastener described above had been designed to be changed with the minimum of delay. It is advantageous to reduce the time taken for changing web covers on the conveyor screens.

In use, with a web cover fitted over a conveyor screen, root crops are harvested. As described above, by the movement imparted through friction to the belt 10, the root crops migrate across the belt 10 with passage through the holes 12 of any soil and debris.

An advantage of having a web cover is that it is readily changed rather than the conveyor screen. If smaller holes or larger holes are required, i.e. a series of web covers can be provided to be used one at a time, each web cover having different sizes of holes. In this way, the requirement to change a conveyor screen with smaller or larger spacings between the rods and consequently different sprockets, is removed.

The belt may be formed in two or more parts, adjacent ends being connected together with fastening means as above described.

Variations and modifications can be made without departing from the scope of the invention described above and as claimed hereinafter.

1. A web cover for an endless conveyor, the cover being formed from a continuous belt of wear-resistant, non-metallic sheet material in which a plurality of closely spaced holes are provided, the web cover being endless and intended to overlie the screen of said conveyor.

2. A web cover as claimed in claim 1, wherein the web cover is formed with the ends of the belt being joined together by fastening means.

3. A web cover as claimed in claim 2, wherein the fastening means comprises two parts, both parts having reflexive sections and having two limbs with one part being secured to each end of the belt with a limb above and below the said end of the belt.

4. A web cover as claimed in claim 3, wherein one part is provided with a lengthwise series of spaced hook elements and the other part being provided with a correspondingly spaced lengthwise series of apertures through which extends and is secured a rod around which each hook element is engagable and is held.

5. A web cover as claimed in claim 4, wherein the elongate belt is for loosely arranging around the screen which itself is arranged around a set of three or more parallel rollers, at least one of which is adapted to be driven, the root crop to be screened being fed onto the upper flight of the cover.

6. A web cover as claimed in claims 4 or 5, wherein the holes in the or each sheet are similar and are provided in a regular pattern across and in particular to providing bridges of material between and at substantially right angles to adjacent parallel rods.

7. An endless conveyor having a web cover as claimed in any one of the preceding claims, in which the cover is loosely arranged around the screen.

8. A conveyor as claimed in claim 7, wherein movement means is provided to vibrate at least the upper flight of the screen and therefore the cover.

9. A web cover for an endless conveyor substantially as hereinbefore described with reference to the accompanying drawings.
